(19) United States
(12) Patent Application Publication
(10) Pub. No.: US 2014/0111496 A1
(43) Pub. Date: Apr. 24, 2014

(54) Displays with Circuitry for Compensating Parasitic Coupling Effects

(71) Applicant: APPLE INC., Cupertino, CA (US)

(72) Inventors: Jason N. Gomez, Campbell, CA (US); Kyung-Wook Kim, Cupertino, CA (US); Szu-Hsien Lee, Cupertino, CA (US)

(73) Assignee: Apple Inc., Cupertino, CA (US)

(21) Appl. No.: 13/657,763

(22) Filed: Oct. 22, 2012

(51) Int. Cl. G06F 3/038; G09G 3/36

(52) U.S. Cl. 345/212; 345/87

(57) ABSTRACT

An electronic device may have a display such as a liquid crystal display. The display may have a color filter layer and a thin-film transistor (TFT) layer. An active portion of the display may contain an array of display pixels that are controlled by control signals that are provided over intersecting gate lines and data lines. In an inactive portion of the display, display driver circuitry may be used to provide data signals for the data lines. Each display pixel may be coupled to a corresponding gate line, data line, and may share a common electrode. Changes in the data signals may be coupled onto the common electrode to cause voltage rippling. Compensation circuitry may be coupled to the common electrode via an AC or a DC coupling connection to help reduce the voltage rippling.

### BACKGROUND

This relates generally to electronic devices and, more particularly, to electronic devices with displays.

Electronic devices such as computers and cellular telephones may have displays. In a typical display such as a liquid crystal display, an array of display pixels is used to display images for a user. Each display pixel may contain a display pixel electrode that is used to apply an adjustable electric field to a portion of a liquid crystal layer. Each display pixel may also share a common electrode carrying a common electrode signal, where the common electrode is formed from a blanket film of transparent conductive material. The magnitude of the electric field from the display pixel electrode to the common electrode in each pixel controls how much light is allowed to pass through the display to the user.

To provide a display such as a liquid crystal display with the ability to display color images, an array of color filter elements may be aligned with the array of display pixels. A color filter array may contain color filter elements such as red, blue, and green color filter elements that are separated from each other by a patterned black masking layer. Portions of the black masking layer may also be used around the periphery of the color filter array. A typical black masking layer is formed from a resin that has been colored with a black pigment such as carbon black.

The liquid crystal layer in a liquid crystal display is sandwiched between an upper layer such as a color filter layer that includes the color filter array and black masking layer and a lower layer such as a thin-film transistor layer. The array of display pixel electrodes and the common electrode that apply the electric fields to the liquid crystal layer may be formed in the thin-film transistor layer. Horizontal gate lines and vertical data lines may be used to apply signals to the display pixels. Display driver circuits that are formed from thin-film transistor circuitry on the thin-film transistor layer may be used to apply data signals to the data lines. Changes to the data signals on the data lines can be coupled via parasitic capacitances to the common electrode, thereby causing ripples in the common electrode signal. The amount of rippling in the common electrode signal may vary across the common electrode blanket region. In areas where excessive rippling is present, undesired color artifacts in the liquid crystal display may arise.

It would therefore be desirable to be able to provide electronic devices with improved displays such as displays with reduced common electrode variations.

### SUMMARY

An electronic device may have a display such as a liquid crystal display. The display may have multiple layers of material such as a color filter layer and a thin-film transistor layer. A layer of liquid crystal material may be interposed between the color filter layer and the thin-film transistor layer.

An opaque masking layer may be formed on a display layer such as the color filter layer. The display may have a central active area such as a rectangular active area. An array of display pixels in the active area may present images to a user of the electronic device. Gate lines and data lines may be used to provide control signals to the display pixels. Each display pixel in the array of display pixels may be configured to apply an electric field to a respective portion of the liquid crystal layer using a display pixel electrode in that display pixel and a common electrode that is shared among all the display pixels. The common electrode may be a blanket region of transparent conductive material (e.g., indium tin oxide) that overlaps with the array of display pixels. The gate lines, data lines, and the common electrode may be formed on the thin-film transistor layer.

The common electrode may be coupled to common electrode compensation circuitry that is formed on a separate circuit board via signal paths formed on a flex circuit (i.e., a flexible cable that connects the circuit board to the thin-film transistor layer). In particular, the common electrode compensation circuitry may have an input that is electrically coupled to the common electrode via a feedback path and an output that provides an output signal that is driven onto the common electrode and that serves to reduce voltage rippling on the common electrode.

In one suitable arrangement, the common electrode compensation circuitry may be coupled to the common electrode via a near-field electromagnetic coupling structure (e.g., a planar conductive structure that overlaps with at least a portion of the common electrode and that is separated from the common electrode by dielectric material). The common electrode compensation circuit may include a wave-shaping attenuating circuit and an inverting amplifier circuit. The wave-shaping attenuating circuit may receive voltage signals from the near-field electromagnetic coupling structure and provide a desired amount of voltage attenuation. The inverting amplifier circuit may receive the attenuated voltage signals and generate a corresponding output voltage signal that is driven onto the common electrode to reduce any existing voltage rippling on the common electrode.

In another suitable arrangement, the common electrode compensation circuitry may receive feedback signals from the common electrode via an impedance isolation circuit. The impedance isolation circuit may be a unity-gain buffer circuit (as an example). The common electrode compensation circuit may include an inverting amplifier and a filter circuit interposed in the feedback path between the impedance isolation circuit and the inverting amplifier. The impedance isolation circuit may serve to decouple the impedance of the common electrode and the feedback path from the input of the common electrode compensation circuitry. The filter circuit may serve to perform high-pass filtering. The inverting amplifier circuit may receive the filtered voltage signals and generate a corresponding output voltage signal that is driven onto the common electrode to reduce any existing voltage rippling on the common electrode.

Further features of the present invention, its nature and various advantages will be more apparent from the accompanying drawings and the following detailed description.

### BRIEF DESCRIPTION OF THE DRAWINGS

FIG. 1 is a cross-sectional side view of an illustrative display in accordance with an embodiment of the present invention.

FIG. 2 is a top view of an illustrative display of the type shown in FIG. 1 in accordance with an embodiment of the present invention.

FIG. 3 is a diagram showing a display common electrode region that is coupled to common electrode compensation circuitry in accordance with an embodiment of the present invention.

FIG. 4 is a timing diagram that illustrates common electrode signal rippling in accordance with an embodiment of the present invention.

FIG. 5 is a diagram showing illustrative common electrode compensation circuitry that includes a common electrode signal amplifier and an electric coupler and isolation circuit in accordance with an embodiment of the present invention.

FIG. 6 is a diagram showing illustrative common electrode compensation circuitry that is coupled to the common electrode via an AC coupling mechanism in accordance with an embodiment of the present invention.

FIG. 7 is a diagram showing illustrative common electrode signal compensation circuitry that is coupled to the common electrode via a DC coupling mechanism in accordance with an embodiment of the present invention.

### DETAILED DESCRIPTION

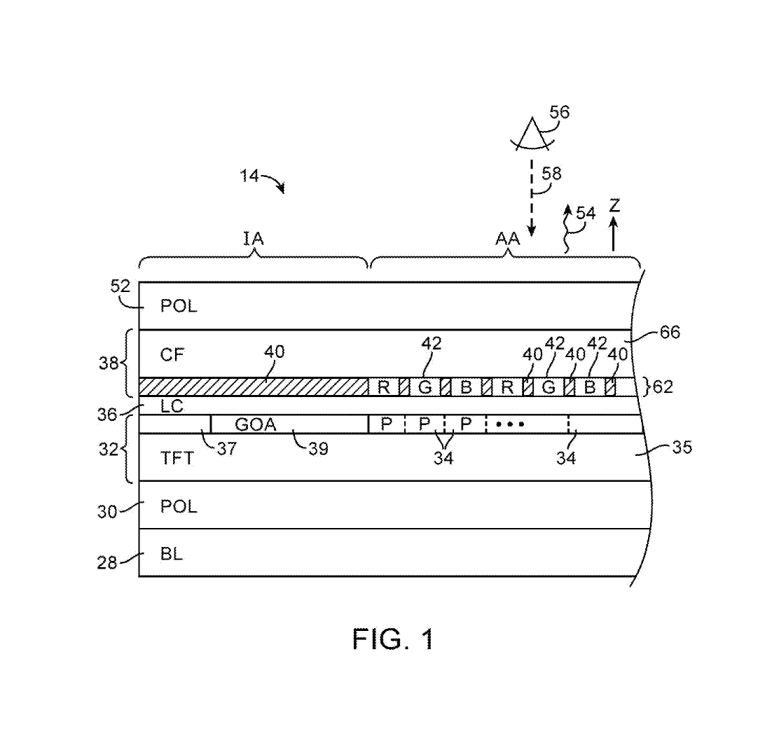

A display such as display 14 of FIG. 1 may be used in an electronic devices such as a computer, a computer that is integrated into a display such as a computer monitor, a laptop computer, a tablet computer, a somewhat smaller portable device such as a wrist-watch device, pendant device, or other wearable or miniature device, a cellular telephone, a media player, a tablet computer, a gaming device, a navigation device, a computer monitor, a television, or other electronic equipment. Displays such as display 14 may use liquid crystal display technology as shown in FIG. 1 or may use other display technologies (e.g., electrophoretic display technology, electrowetting display technology, organic light-emitting diode display technology, plasma display technology, etc.). The use of liquid crystal display components in implementing display 14 is merely illustrative.

Display 14 may be a touch screen that incorporates capacitive touch electrodes or other touch sensor components or may be a display that is not touch sensitive. Display 14 may be mounted in an electronic device housing. Electronic device housing structures in which display 14 may be mounted may be formed of plastic, glass, ceramics, fiber composites, metal (e.g., stainless steel, aluminum, etc.), other suitable materials, or a combination of any two or more of these materials. The housing may be formed using a unibody configuration in which some or all of the housing is machined or molded as a single structure or may be formed using multiple structures (e.g., an internal frame structure, one or more structures that form exterior housing surfaces, etc.).

Display 14 may have an inactive portion such as inactive portion IA that surrounds an active portion such as active portion AA. Active region AA may, for example, form a rectangular central portion of display 14 (when viewed in direction 58 by viewer 56) and may be surrounded by an inactive region IA with the shape of a rectangular ring. Display 14 may have other active area shapes and inactive area shapes, if desired. Configurations in which an inactive region IA extends along each of the four edges of a rectangular active region AA are described herein as an example.

As shown in FIG. 1, display 14 may have a layer of liquid crystal material such as liquid crystal material 36 that is sandwiched between display layers such as color filter layer 38 and thin-film transistor layer 32. Upper polarizer 52 may be formed above color filter layer 38. Lower polarizer 30 may be formed below thin-film transistor layer 32.

Thin-film transistor layer 32 may have an array of display pixels 34 (e.g., pixels P) in active area AA. Each display pixel may have a display pixel electrode for applying an electric field to a corresponding portion of liquid crystal layer 36. The display pixel electrodes may be controlled by thin-film transistor circuitry on thin-film transistor layer 32. For example, each display pixel P may contain a thin-film transistor having a gate that is coupled to a gate line. Thin-film transistors may also be used in forming gate driver circuitry 39 (sometimes referred to as gate on array circuitry or GOA circuitry). The gate driver circuitry may drive gate signals onto the gate lines. Additional structures 37 (e.g., metal traces) may run along the outer edge of gate driver circuitry 39.

Thin-film transistor layer 32 may have a substrate such as substrate 35. Substrate 35 may be a clear glass layer or a layer of other transparent material such as a layer of polymer. Thin-film transistor circuitry such as thin-film transistors, metal lines, patterned electrodes for display pixels 34, and other structures may be formed on substrate 35.

The thin-film transistor circuitry of thin-film transistor layer 32 may include amorphous silicon transistor circuitry or polysilicon transistor circuitry. Interconnect lines may be used to connect electrodes formed from conductive materials such as indium tin oxide and metal to thin-film structures such as thin-film transistors.

The electrodes in the thin-film transistor circuitry of thin-film-transistor layer 32 may be used to produce electric fields that control the orientation of liquid crystals in liquid crystal layer 36. Backlight unit 28 may be used to produce backlight 54 for display 14. Backlight 54 may pass through display 14 in vertical direction Z. This provides illumination for display 14 so that a user such as viewer 56 who is observing display 14 in direction 58 may clearly observe images that are produced by the display pixels in active area AA.

By controlling the orientation of the liquid crystals in layer 36, the polarization of backlight 54 may be controlled. In combination with the presence of polarizer layers 30 and 52, the ability to control the polarization of the light passing through individual pixels of liquid crystal material 36 provides display 14 with the ability to display images for viewer 56.

Backlight unit 28 may include a light source such as a light-emitting diode array for producing backlight 54. Polarizers such as polarizer 30 and polarizer 52 may be formed from thin polymer films.

If desired, display 14 may be provided with layers for reducing fingerprints (e.g., a smudge-resistant coating in a touch-sensitive display), anti-scratch coatings, an antireflection coating, a layer for reducing the impact of static electricity such as indium tin oxide electrostatic discharge protection layer, or other layers of material. The display layers that are used in the illustrative configuration of FIG. 1 are merely illustrative.

Display 14 may include a color filter layer such as color filter layer 38. Color filter layer 38 may include a color filter layer substrate such as substrate 66. Substrate 66 may be formed from a clear layer of material such as glass or plastic.

Color filter layer 38 may include an array of color filter elements 42 formed on substrate 66. Color filter elements 42 may include, for example, red elements R, green elements G, and blue elements B. The array of color filter elements in color filter layer 38 may be used to provide display 14 with the ability to display color images. Each of display pixels P in thin-film transistor layer 34 may be provided with a respective overlapping color filter element 42.

Adjacent color filter elements 42 may be separated by interposed portions of opaque masking material 40. Opaque masking material 40 may be formed from a dark substance such as a polymer that contains a black pigment. Opaque masking material 40 may therefore sometimes be referred to as a black mask, black masking layer, black pigmented layer, or black masking material. Illustrative polymeric materials for forming black masking layer 40 include acrylic-based and polyimide-based photoresists. An illustrative black pigment that may be used for black masking layer 40 is amorphous carbon (e.g., carbon black).

In active region AA, black mask 40 may be formed from a grid of relatively thin lines (sometimes referred to as a black matrix). The black matrix may have a pattern of openings such as an array of rectangular holes for receiving color filter elements. In inactive region IA, black masking material may be used in forming a peripheral black mask that serves as a black border for display 14. The black mask in inactive area IA may have a rectangular ring shape that surrounds a central rectangular active area AA (as an example).

Color filter elements 42 and black masking layer 40 may form layer 62 on the lower surface of substrate 66. Thin-film transistor layer 32 may include gate driver circuitry 39 for producing gate control signals (gate line voltage V_{GL}) for controlling thin-film transistors in display pixels 34. Gate driver circuitry 39 may be powered using a positive power supply voltage and a ground power supply voltage (as examples). Display pixels 34 may be provided with a common electrode signal (sometimes referred to as Vcom) using a blanket film of a transparent conductor such as indium tin oxide. Gate driver circuitry 39 may extend along the edge of the array of display pixels in active area AA. There may be, for example, a strip of gate driver circuitry 39 along the left and right edges of display 14.

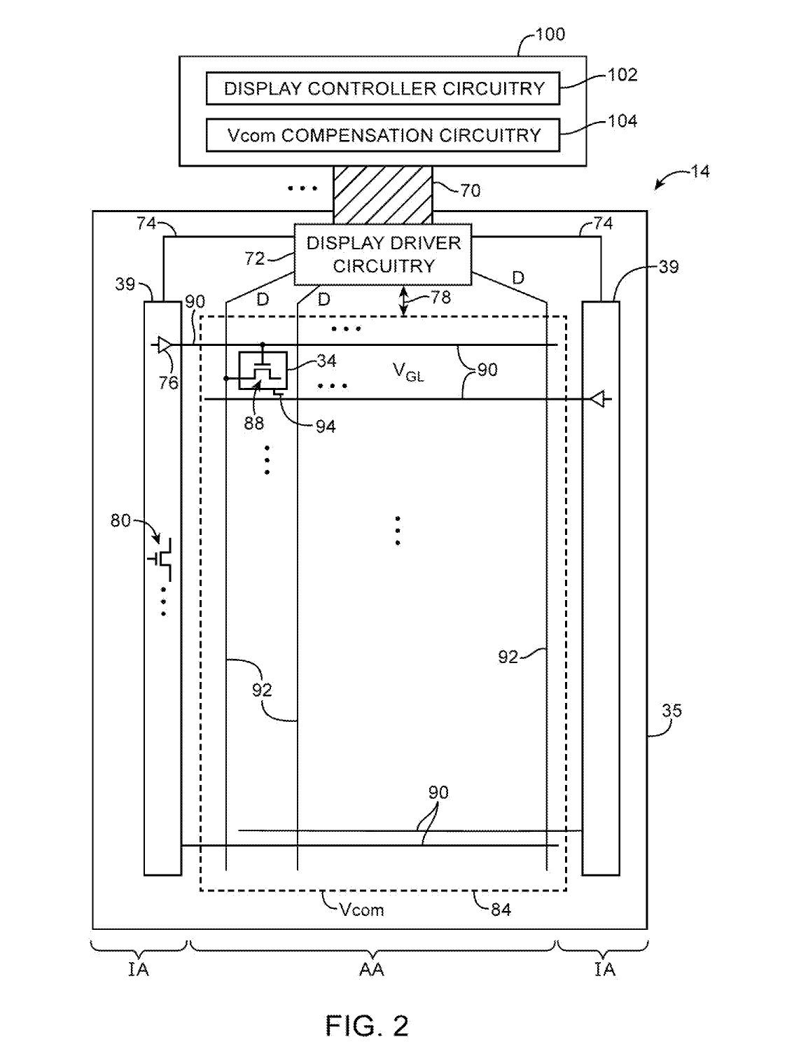

A top view of display 14 showing an illustrative configuration that may be used for implementing gate driver circuitry and other circuitry in display 14 is shown in FIG. 2. As shown in FIG. 2, display 14 may be coupled to one or more integrated circuits on printed circuit board 100 via a cable such as a cable formed from conductive metal traces in flex circuit 70 (as an example). Circuitry such as display controller circuitry 102 and display common electrode signal (Vcom) compensation circuitry 104 may be formed on board 100. Circuitries 102 and 104 may be formed on one or more integrated circuits.

During operation of display 14 in device 10, control circuitry 102 may be used to generate information to be displayed on display 14 (e.g., display data). Control circuitry 102 may include processing circuitry (e.g., a microprocessor, microcontroller, application-specific integrated circuit, or other processor) and storage (e.g., random-access memory, read-only memory, non-volatile memory, volatile memory, or other suitable storage) that may be used in providing content to display 14 via cable 70. The information to be displayed may be conveyed from circuitry 104 to display driver circuitry 104 via signal path 70. The content to be displayed on display 14 may include text, graphics, still images, and moving video.

Display driver circuitry 72 may receive the content that is to be displayed from cable 70. Display driver circuitry 72 may be mounted on a ledge of thin-film transistor substrate layer 35 or other suitable portion of display 14. Display driver circuitry 72 may be implemented using an integrated circuit (e.g., a display driver integrated circuit) and/or additional circuits (e.g., thin-film circuitry and/or circuitry that is external to display 14).

Display driver circuitry 72 may provide gate driver circuitry 39 with control signals such as clock signals on paths 74. Gate driver circuitry 39 may include thin-film transistor circuitry such as thin-film transistor 80. Gate line drivers 76 may be used to control gate line voltages V_{GL} on data lines 90. Each gate driver circuit 39 may include thin-film transistors such as thin-film transistor 80 and conductive lines such as portions of gate lines 90 and power supply lines.

Active area AA of display 14 may include an array of vertical lines such as data lines 92 (carrying data signals D) and an array of horizontal lines such as gate lines 90 (carrying gate line signals V_{GL}). An array of display pixels 34 may be controlled using signals on data lines 92 and gate lines 90. Each display pixel 34 may, as an example, include a thin-film transistor such as transistor 88. When an associated gate line 90 is taken high, transistors such as transistor 88 in that row of the array will be turned on and will pass a corresponding data signal D to an associated display pixel electrode, thereby applying an electric field that is proportional to data signal D to a pixel-sized region of liquid crystal layer 36 (see, e.g., FIG. 1).

A blanket region of transparent conductive film material such as a rectangular indium tin oxide layer may be used to form common electrode 84. Common electrode 84 may carry voltage Vcom for pixels 34 (e.g., to pixel terminals such as pixel terminal 94) and may sometimes be referred to as a Vcom electrode. Conductive lines (e.g., metal lines) such as line 78 may be used to carry voltages to common electrode 84 such as voltage Vcom. In some configurations for display 14, there may be multiple Vcom values (e.g., Vcom1 and Vcom2) and multiple corresponding Vcom electrodes separated by one or more gaps. In the arrangement of FIG. 2, display 14 has a single common electrode 84 that is provided with a single Vcom voltage using Vcom line 78.

During operation, display driver circuitry 72 may provide data signals D to pixels 34. Data lines 92 may be formed over the Vcom electrode 84. Parasitic capacitance may be present between data lines 92 and Vcom electrode 84. The presence of this type of parasitic capacitance can give rise to capacitive coupling between the data lines and the common electrode 84. Changes to the data signals on data lines 92 may therefore be capacitively coupled to Vcom electrode 84 and may result in temporary voltage perturbations in common electrode signal Vcom. Temporary voltage perturbations or rippling in signal Vcom generated in this way may adversely affect the performance of display 14. For example, Vcom rippling may cause display 14 to exhibit unwanted color cast.

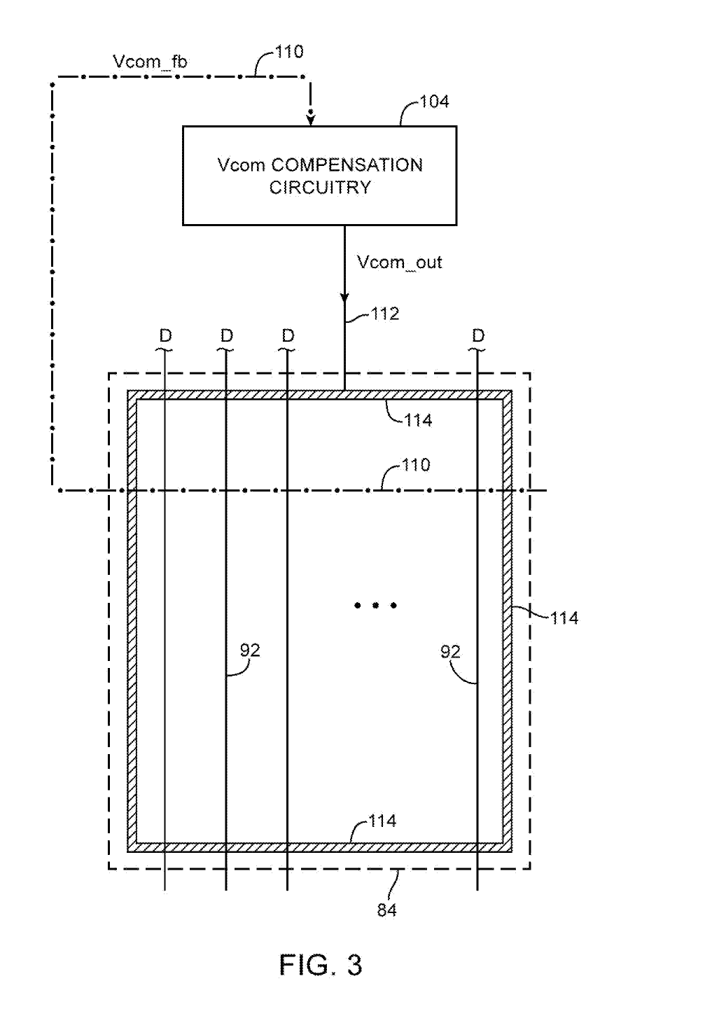

Common electrode Vcom compensation circuitry 104 formed on board 100 may be used to compensate for this undesired Vcom rippling. Compensation circuitry 104 may be used in sensing perturbations in Vcom and may generate a corresponding corrected Vcom output signal that helps to reduce the amount of Vcom rippling. FIG. 3 is a diagram showing how Vcom region 84 may be coupled to Vcom compensation circuitry 104. As shown in FIG. 3, Vcom compensation circuitry 104 may have an input that receives common electrode feedback signal Vcom_fb via path 110 and an output on which signal Vcom_out is generated.

Feedback path 110 may be electrically coupled to region 84 and may be formed underneath at least some of data lines 92 so as to improve sensitivity to changes in Vcom that result from variations in the data signals. In one suitable arrangement, feedback path 110 may be coupled to region 84 via a direct-current (or “DC”) connection. In another suitable arrangement, feedback path 110 may be coupled to region 84 via a floating connection (e.g., via an antenna coupling mechanism sometimes referred to as an alternating-current or “AC” connection).

Signal Vcom_out that is generated at the output of Vcom compensation circuitry 104 may be fed to Vcom distribution path 114 via path 112. In the example of FIG. 3, path 114 may be formed as a ring-shaped conductor that is shorted to common electrode region 84. Formed in this way, compensation output signal Vcom_out may be distributed to various portions of region 84 in a relatively uniform fashion. This is merely illustrative. If desired, Vcom_out may be injected at more than one location on region 84, conductor 84 may traverse a central portion of region 84 and may be formed using any suitable shape or pattern of conductive lines, etc. Paths 110 and 112 interposed between common electrode 84 and Vcom compensation circuitry 104 may be formed on cable 70 (FIG. 2).

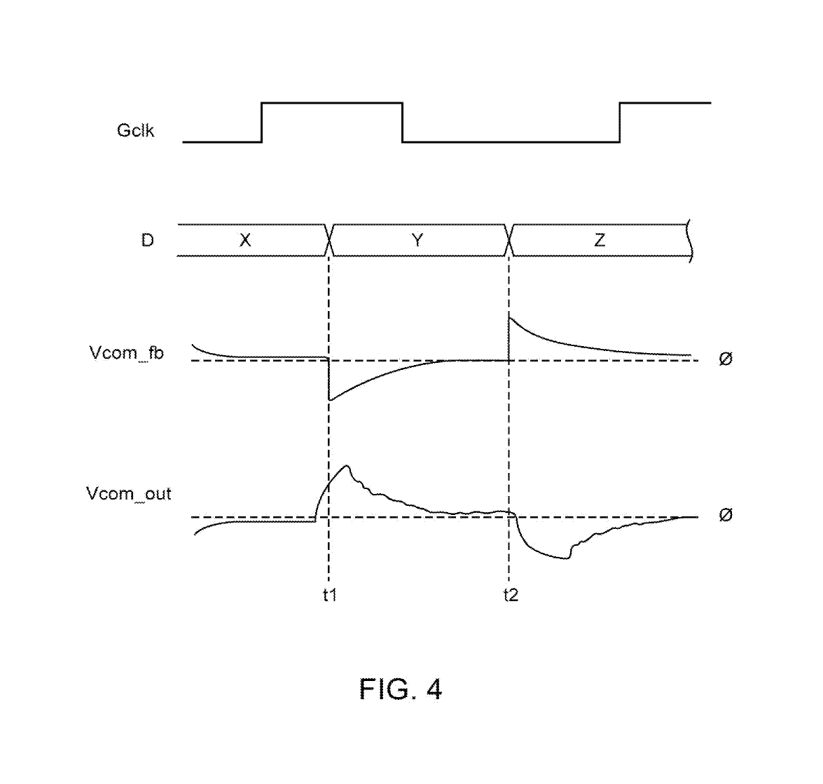

FIG. 4 is a timing diagram that illustrates the operation of Vcom compensation circuitry 104. As shown in FIG. 4, data signal D may change values when gate clock signal Gclk is high (e.g., at time t1) and when Gclk is low (e.g., at time t2). Gate clock signal Gclk may control the latching of data signals onto the data lines. Changes in the data signal may result in undesired voltage perturbations in common electrode signal Vcom, which can be sensed using signal Vcom_fb on feedback path 110. In the example of FIG. 4, the change in data signal D from “X” to “Y” at time t1 may cause a temporary voltage drop in Vcom (e.g., as indicated by Vcom_fb dropping below a nominal voltage level of zero voltages), whereas the change in data signal D from “Y” to “Z” at time t2 may cause a temporary voltage rise in Vcom (e.g., as indicated by Vcom_fb rising above the nominal Vcom voltage level). Rippling caused by data line coupling may be acceptable if common electrode signal Vcom settles back to its nominal voltage level within a specified time period. In practice, however, there may be certain portions of region 84 that exhibit slower settling times, resulting in undesired color artifacts in those portions of display 14.

Common electrode signal Vcom compensation circuitry 104 may receive signal Vcom_fb and may output signal Vcom_out that is an inverted and amplified version of signal Vcom_fb (see, FIG. 4). Signal Vcom_out generated in this way may be injected into region 84 so as to compensate for any undesired rippling caused by variations in the data signals. In other words, signal Vcom_out being injected into region 84 may serve to substantially cancel out any voltage perturbations as sensed using Vcom_fb.

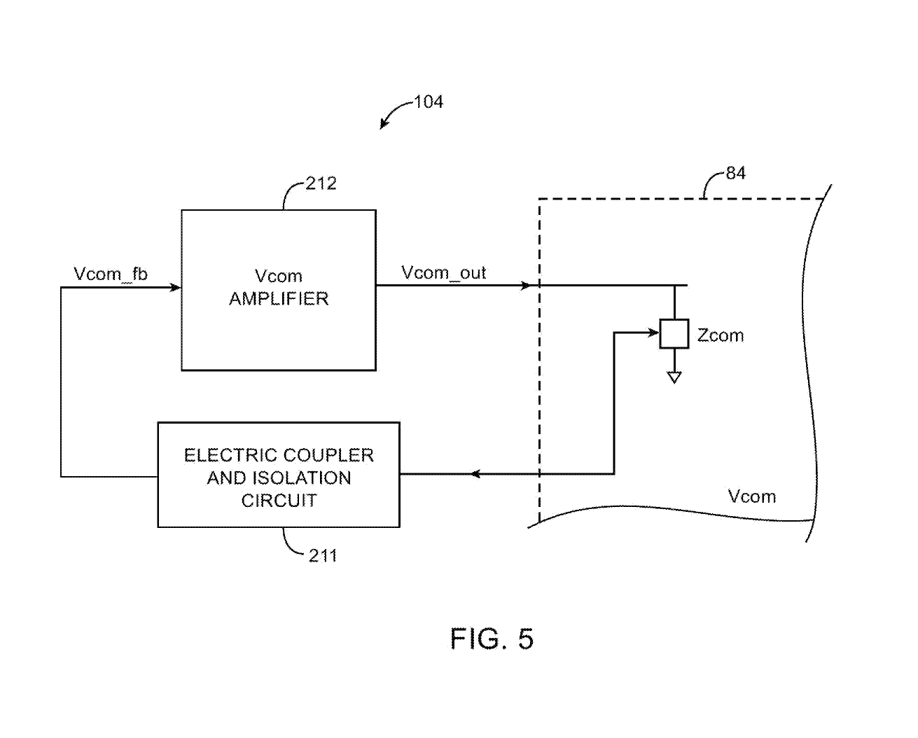

Vcom compensation circuitry 104 may include signal amplifying circuit such as a Vcom amplifier 212 (see, e.g., FIG. 5). As shown in FIG. 5, Vcom amplifier 212 may have an input that receives feedback signal Vcom_fb from region 84 via an electric coupler and isolation circuit 211 and an output on which signal Vcom_out is generated. Common electrode region 84 may have a total associated impedance value as represented by impedance Zcom. Circuit 211 may include circuitry for electrically coupling to region 84 (e.g., coupling circuitry for sensing Vcom rippling in region 84) and may optionally include circuitry for isolating impedance Zcom from amplifier 212. Isolating Zcom from amplifier 212 may allow for improved ease and flexibility in tuning amplifier 212 to obtain the desired Vcom_out waveform without having to take into account the impedance of the feedback path and the impedance of the common electrode.

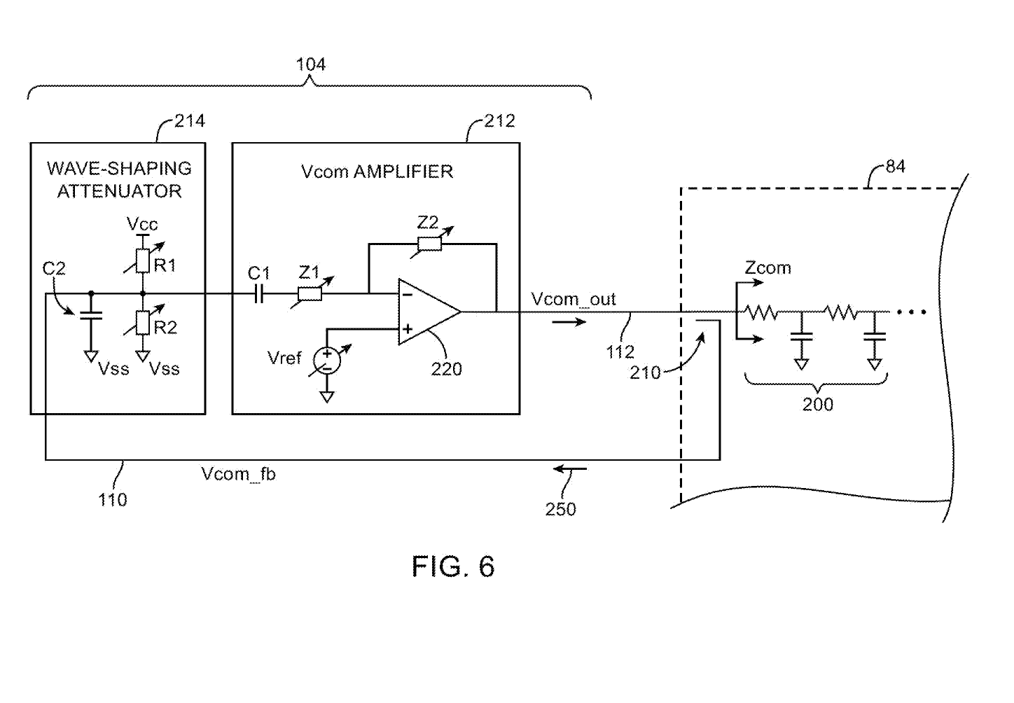

FIG. 6 shows one embodiment of the present invention in which common electrode region 84 is electrically coupled to Vcom compensation circuitry 104 via an AC coupling connection 210. As shown in FIG. 6, Vcom compensation circuitry 104 may include a Vcom amplifier 212 that receives Vcom_fb via a wave-shaping attenuator 214 and AC coupler 210. The impedance of the common electrode (Zcom) may be modeled using a distributed load network such as network 200 having series resistances and shunt capacitances. AC coupler 210 may be formed using a conductive strip that is separated from Vcom region 84 by dielectric material and that is capable of sensing voltage changes in Vcom via a near-field wireless coupling mechanism (e.g., coupler 210 may be a planar conductive structure that overlaps with at least a portion of region 84). AC coupler 210 may therefore sometimes be referred to as a near-field antenna probing structure or a near-field electromagnetic coupling structure.

Voltage variations picked up using AC coupler 210 may be fed back to Vcom compensation circuitry 104 via path 110, as indicated by arrow 250. AC coupler 210 may simultaneously serve as an electric coupler and an impedance isolation circuit (e.g., near-field coupling effectively isolates the feedback path from the common electrode impedance).

In the implementation of FIG. 6, common electrode feedback signal Vcom_fb may be fed through wave-shaping attenuator 214. Attenuator 214 may serve to reduce the magnitude of voltage swings in Vcom_fb so that the attenuated Vcom_fb can be properly handled by Vcom amplifier 212. Attenuator 214 may include a first resistor R1 coupled between a positive power supply line (e.g., a power supply line on which positive power supply signal Vcc is provided) and path 110, a second resistor R2 coupled between path 110 and a ground power supply line (e.g., a ground line on which ground power supply signal Vss is provided), and a capacitive circuit C2 that is coupled between path 110 and the ground line. Resistors R1 and R2 can be adjustable resistive circuits or other suitable adjustable load circuits. Resistors R1 and R2 may, for example, be tuned so as to provide the desired attenuation factor (e.g., R1 and R2 may be adjusted to help shape the feedback waveform). Capacitive circuit C2 may serve as a stray capacitor that provides a current path for discharging the intermediate node connecting resistor R1 to R2.

The attenuated waveform may be received at an input of Vcom amplifying circuit 212. Amplifying circuit 212 may include an operational amplifier 220, a capacitor C1, a first load component Z1, and a second load component Z2. Operational amplifier 220 may have a first (positive) input that receives a Vcom reference voltage Vref from an adjustable voltage source, a second (negative) input, and an output that serves as the output for Vcom amplifier circuit 212 (e.g., signal Vcom_out may be generated at the output of operational amplifier 220). Reference voltage Vref may be set to a predetermined nominal voltage for the Vcom electrode. As an example, Vref may be set to zero volts. If desired, Vref may be adjusted to voltages other than zero volts.

Load component Z2 may have a first terminal that is coupled to the second input of amplifier 220 and a second terminal that is coupled to the output of amplifier 220. Capacitor C1 and load component Z1 may be coupled in series between the input of Vcom amplifying circuit 212 and the second input of amplifier 220. The arrangement of amplifier 212 in FIG. 6 may sometimes be referred to as an inverting amplifier configuration. Component C1 may serve as a coupling capacitor for receiving only the high-frequency signal component of Vcom_fb. Load components Z1 and Z2 may be adjustable resistors, capacitors, inductors, or other suitable tunable electric components. Load components Z1 and Z2 may exhibit impedances that can be tuned so that Vcom amplifier 212 provides the desired gain factor. The gain provided by amplifier 212 may, for example, be negative.

Signal Vcom_out generated at the output of Vcom amplifier 212 may be injected back into common electrode 84 via path 112 (see, e.g., FIGS. 3 and 6). Attenuator 214 and amplifier 212 of the type describe in connection with FIG. 6 are merely illustrative and do not serve to limit the scope of the present invention. If desired, attenuator 214 may be implemented using other suitable voltage attenuating or wave-shaping circuit architectures, whereas amplifier 212 may be implemented using other types of inverting amplifier configurations.

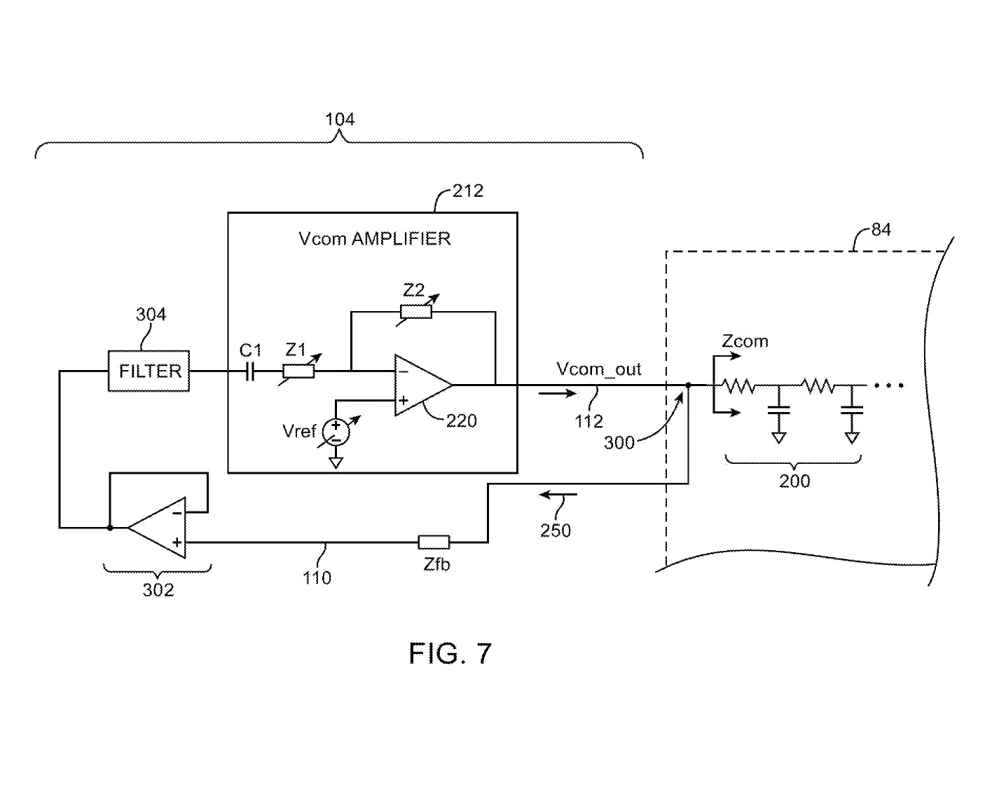

FIG. 7 shows another embodiment of the present invention in which common electrode region 84 is electrically coupled to Vcom compensation circuitry 104 via a DC coupling connection 300. As shown in FIG. 7, Vcom compensation circuitry 104 may include a Vcom amplifier 212 that receives Vcom_fb via a unity-gain amplifier 302 and a filter 304. Feedback path 110 may be shorted to common electrode 84. Voltage variations present at DC connection point 300 may be fed back to Vcom compensation circuitry 104 via path 110, as indicated by arrow 250.

In the implementation of FIG. 7, common electrode feedback signal Vcom_fb may be fed through unity-gain amplifier 302 (e.g., an operational amplifier with an output that is shorted to its negative input). Unity-gain amplifier 302 may sometimes be referred to as a unity-gain buffer. Buffer 302 may provide a non-inverting gain of one and may serve as an impedance isolation circuit that isolates amplifier 212 from the common electrode impedance Zcom and the impedance of the feedback path (as modeled by Zfb). Decoupling Zfb and Zcom in this way allows for components C1, Z1, and Z2 to be independently tuned without having to take into account feedback impedance.

Unity-gain buffer 302 may have an output that is coupled to Vcom amplifier 212 via filter 304. Filter 304 may be a high-pass filter or other suitable pre-emphasis circuit for passing signal components higher than a desired frequency threshold. The filtered signal may then be received at the input of Vcom amplifying circuit 212. As described in connection with FIG. 6, Vcom amplifier may be appropriately tuned to provide the desired inverting gain factor.

Signal Vcom_out generated at the output of Vcom amplifier 212 may be injected back into common electrode 84 via path 112 (see, e.g., FIGS. 3 and 7). Buffer 302 and high-pass filter 304 of the type described in connection with FIG. 7 are merely illustrative and do not serve to limit the scope of the present invention. If desired, buffer 302 may be implemented using other suitable unity-gain configurations or other voltage buffering architectures, whereas circuit 304 may be other types of filters (e.g., low-pass filters, band-pass filters, notch filters, etc.) and other types of pre-emphasis or wave-shaping circuit.

The foregoing is merely illustrative of the principles of this invention and various modifications can be made by those skilled in the art without departing from the scope and spirit of the invention. The foregoing embodiments may be implemented individually or in any combination.

What is claimed is:

1. A display comprising:
an array of display pixels controlled by data lines and gate lines, wherein each display pixel in the array of display pixels has an associated display pixel electrode and wherein the array of display pixels share a common electrode; and
common electrode compensation circuitry configured to reduce voltage rippling on the common electrode, wherein the common electrode compensation circuitry is coupled to the common electrode via a near-field electromagnetic coupling structure.

2. The display defined in claim 1, further comprising:
a liquid crystal layer, wherein each display pixel in the array of display pixels is configured to apply an electric field to a respective portion of the liquid crystal layer using the display pixel electrode in that display pixel and the common electrode.

3. The display defined in claim 1, wherein the near-field electromagnetic coupling structure comprises a planar conductive structure that overlaps with at least a portion of the common electrode and that is separated from the common electrode by dielectric material.

4. The display defined in claim 1, wherein the common electrode comprises a blanket region of transparent conductive material that overlaps with the array of display pixels.

5. The display defined in claim 1, wherein the common electrode compensation circuitry has an input that is coupled to the common electrode via the near-field electromagnetic coupling structure and has an output that is shorted with the common electrode.

6. The display defined in claim 5, wherein the common electrode compensation circuitry includes an inverting amplifier circuit that drives the output of the common electrode compensation circuitry.

7. The display defined in claim 6, wherein the common electrode compensation circuitry further includes a voltage attenuating circuit interposed between the input of the common electrode compensation circuitry and the inverting amplifier circuit.

8. The display defined in claim 7, wherein the voltage attenuating circuit comprises:
a first load component coupled between a first power supply line and the input of the common electrode compensation circuitry;
a second load component coupled between the input of the common electrode compensation circuitry and a second power supply line that is different than the first power supply line; and
a capacitor that is coupled between the input of the common electrode compensation circuitry and the second power supply line.

9. The display defined in claim 1, wherein the common electrode compensation circuitry is coupled to the common electrode via a flex circuit.

10. A display comprising:
an array of display pixels controlled by data lines and gate lines, wherein each display pixel in the array of display pixels has an associated display pixel electrode and wherein the array of display pixels share a common electrode; and
common electrode compensation circuitry configured to reduce voltage rippling on the common electrode, wherein the common electrode compensation circuitry includes an input that is coupled to the common electrode via a feedback path, an output that is coupled to the common electrode via an output path, and an impedance isolation circuit that is interposed in the feedback path.

11. The display defined in claim 10, further comprising:
a liquid crystal layer, wherein each display pixel in the array of display pixels is configured to apply an electric field to a respective portion of the liquid crystal layer using the display pixel electrode in that display pixel and the common electrode.

12. The display defined in claim 10, wherein the common electrode comprises a blanket region of transparent conductive material that overlaps with the array of display pixels.

13. The display defined in claim 10, where the impedance isolation circuit comprises a unity-gain buffer circuit.

14. The display defined in claim 10, wherein the common electrode compensation circuitry further includes an inverting amplifier that drives the output of the common electrode compensation circuitry.

15. The display defined in claim 14, wherein the common electrode compensation circuitry further includes a filter circuit interposed in the feedback path between the impedance isolation circuit and the inverting amplifier.

16. The display defined in claim 15, wherein the filter circuit comprises a high-pass filter.

17. The display defined in claim 10, wherein at least a portion of the feedback path and the output path interposed between the common electrode compensation circuitry and the common electrode is formed on a flex circuit.

18. A method of operating a display having a plurality of display pixels that are controlled by data lines and gate lines, wherein each display pixel in the array of display pixels has an associated display pixel electrode and wherein the array of display pixels share a common electrode, the method comprising:
applying data signals on the data lines;
in response to applying the data signals on the data lines, receiving a feedback signal from the common electrode with common electrode compensation circuitry via an impedance isolation circuit; and
with the common electrode compensation circuitry, driving the common electrode to reduce voltage rippling on the common electrode.

19. The method defined in claim 18, wherein the impedance isolation circuit comprises a near-field electromagnetic coupling structure, and wherein receiving the feedback signal comprises receiving the feedback signal from the common electrode with common electrode compensation circuitry via the near-field electromagnetic coupling structure.

20. The method defined in claim 19, wherein the near-field electromagnetic coupling structure comprises a planar conductive structure that overlaps with at least a portion of the common electrode and that is separated from the common electrode by dielectric material.

21. The method defined in claim 19, wherein the common electrode compensation circuitry includes a voltage attenuator circuit and an inverting amplifier, the method further comprising:
with the voltage attenuator circuit, attenuating the feedback signal; and
with the inverting amplifier, amplifying the attenuated feedback signal to generate a corresponding output voltage signal that is driven onto the common electrode to reduce any existing voltage rippling on the common electrode.

22. The method defined in claim 18, wherein the impedance isolation circuit comprises a unity-gain buffer circuit, and wherein receiving the feedback signal comprises receiving the feedback signal from the common electrode with common electrode compensation circuitry via the unity-gain buffer circuit.

23. The method defined in claim 22, wherein the unity-gain buffer has an input that is shorted to the common electrode.

24. The method defined in claim 23, wherein the common electrode compensation circuitry includes a filter circuit and an inverting amplifier, the method further comprising:
with the filter circuit, performing high-pass filtering on the feedback signal; and
with the inverting amplifier, amplifying the filtered feedback signal to generate a corresponding output voltage signal that is driven onto the common electrode to reduce any existing voltage rippling on the common electrode.
